(19) United States
(12) Patent Application Publication
(10) Pub. No.: US 2024/0237145 A1
(43) Pub. Date: Jul. 11, 2024

(54) HANDLING AD HOC GROUP CALL PARTICIPATION IN MC NETWORK

(71) Applicant: Samsung Electronics Co., Ltd., Suwon-si (KR)

(72) Inventors: Kiran Gurudev KAPALE, Bangalore (IN); Arunprasath RAMAMOORTHY, Bangalore (IN)

(21) Appl. No.: 18/406,725

(22) Filed: Jan. 8, 2024

(30) Foreign Application Priority Data
Jan. 9, 2023 (IN) 202341001692
Dec. 9, 2023 (IN) 2023 41001692

(51) Int. Cl. H04W 76/45; H04W 76/30

(52) U.S. Cl. CPC H04W 76/45; H04W 76/30

(57) ABSTRACT

The disclosure relates to a fifth generation (5G) or sixth generation (6G) communication system for supporting a higher data transmission rate. A method and a mission critical (MC) network for handling an ad hoc group call participation in the MC network are provided. The method includes transmitting an ad hoc group call add user notification message to a primary MC server when a criteria to add a MC client to an established ad hoc group call is met. The ad hoc group call add user notification message includes a MC service ad hoc group identifier associated with the ad hoc group call, and a MC service identifier list meeting the criteria specified in the ad hoc group call.

### CROSS-REFERENCE TO RELATED APPLICATION(S)

This application is based on and claims priority under 35 U.S.C. § 119(a) of an Indian Provisional patent application number 202341001692, filed on Jan. 9, 2023, in the Indian Patent Office, and of an Indian Non-Provisional patent application number 202341001692, filed on Dec. 9, 2023, in the Indian Patent Office, the disclosure of each of which is incorporated by reference herein in its entirety.

### BACKGROUND

### 1. Field

The disclosure relates to field of mission critical (MC) services that are used by public safety communities (such as police, military, fire services, ambulance crews, and many more) and railways in operations that require high reliability, speed, quick accessibility and low latency operational support. More particularly, the disclosure relates to a method and a MC network for handling an ad hoc group call participation in the MC network.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

In the mission critical services for the public safety and railways, the mission critical services require an Ad hoc group call support. The Ad hoc group call support is established based on a criteria shared by a MC service user and participants determined by a MC service server. An ad hoc group call setup involves the MC service user from multiple MC systems (or MCPTT provider). A primary MC system is responsible for handling of the ad hoc group call. If the primary MC system needs to involve a partner system, based on agreement and criteria for determining a participants list, then all the involved partner MC systems are responsible to provide participants from their MC system those who meet the criteria or no longer meet the criteria. During call setup of the ad hoc group call, the primary MC system uses the criteria to determine the MC service users who may participate in the ad hoc group call. The primary MC system sends an ad hoc group call get userlist request along with the criteria to determine the participants to the partner MC system. On receiving of the ad hoc group call get userlist request, the MC services user who meets the criteria are returned to the primary MC system. The primary MC system invites all the determined MC service user to the ad hoc group call. The primary and partner MC systems continuous to monitor and determine the MC service users based on the criteria. During continuous determination of the MC service users by the partner MC system, if any of the MC service user meets or no longer meet the criteria, the primary MC system should be notified. On receiving of the notification, the MC services user who meets the criteria may be added to an on-going ad hoc group call and those MC services users who no longer meets the criteria may be removed from the ongoing ad hoc group call. Similarly, the on-going ad hoc group call to be released then, the partner MC system is notified to stop determining the participants for the ad hoc group call using the criteria. But, currently there is no mechanisms exists through which the partner MC system will notify the primary system about any changes related to the MC service user who meets or no longer meets the criteria while doing continuous to determination. Similarly, there is no mechanism exists through which the partner system is notified to stop determining the participants for the ad hoc group call using the criteria if the on-going ad hoc group call to be released.

FIGS. 1A and 1B show a flow diagram of existing mechanism of the ad hoc group call setup involving multiple Mission-Critical Push-To-Talk (MCPTT) systems, according to the related art. FIGS. 1A and 1B illustrate a scenario of success case of the ad hoc group call setup involving multiple MC systems. The multiple MC systems allows the MC service users from the primary MC system and the partner MC system to participate in the ad hoc group call. Both, the primary and partner MC systems continue to monitor and determine the MC services users based on the criteria. Thus, it is important for the partner MC systems to notify the primary MC system on continuous determination of the MC service user from the partner system based on the criteria. The MC service users meets or no longer meet the criteria. Based on the notification, the MC service users are either added to the ongoing ad hoc group call or removed from the ongoing ad hoc group call. Similarly, notify about the release of the ad hoc group call to the partner MC system by the primary MC system to stop determining the participants for the ad hoc group call.

Referring to FIGS. 1A and 1B, At operation 1, the first MCPTT client (or MC client) 102a sends an ad hoc group call request to a primary MC server (e.g., primary MCPTT server) 104. At operation 2, the primary MC server 104 authorizes the ad hoc group call request. At operation 3, the primary MC server 104 sends an ad hoc group call request return to the first MCPTT client 102a. At operation 4, the primary MC server 104 determines the list of participants to be invited for the call based on the rule set specified in operation 1. In an example, the rule set is determined based on certain distance based on location and a role of the user.

At operation 5, the primary MC server 104 sends an ad hoc group call get user list to the partner MC server (e.g., partner MCPTT server, and the like) 106. At operation 6, the partner MC server 106 sends the ad hoc group call get user list response to the primary MC server 104. At operation 7, the primary MC server 104 sends the ad hoc group call request to the partner MC server 106.

At operation 8a, the partner MC server 106 sends the ad hoc group call request to a third MCPTT client 102c. At operation 8b, the partner MC server 106 sends the ad hoc group call request to a fourth MCPTT client 102d. At operation 9, the primary MC server 104 sends the ad hoc group call request to the second MCPTT client 102b. At operation 10a, the second MCPTT client 102b notifies the ad hoc group call. At operation 10b, the third MCPTT client 102c notifies the ad hoc group call. At operation 10c, the fourth MCPTT client 102d notifies the ad hoc group call. At operation 11, the second MCPTT client 102b sends an ad hoc group call response to the primary MC server 104. At operation 12a, the third MCPTT client 102c sends the ad hoc group call response to the partner MC server 106. At operation 12b, the fourth MCPTT client 102c sends the ad hoc group call response to the partner MC server 106.

At operations 13a and 13b, the partner MC server 106 sends the ad hoc group call response to the primary MC server 104. At operation 14, the primary MC server 104 sends the ad hoc group call response to the first MCPTT client 102a. At operation 15, the primary MC server 104 sends the ad hoc group call notify to the first MCPTT client 102a. At operation 16, a media plane and floor control establishment are done among the primary MC server 104, the partner MC server 106 and the MCPTT clients 102a-102d.

The above information is presented as background information only to assist with an understanding of the disclosure. No determination has been made, and no assertion is made, as to whether any of the above might be applicable as prior art with regard to the disclosure.

### SUMMARY

In line with development of the communication systems, there is a need for handling an ad hoc group call participation in the MC network.

Aspects of the disclosure are to address at least the above-mentioned problems and/or disadvantages and to provide at least the advantages described below. Accordingly, an aspect of the disclosure is to provide a method and a MC network for handling an ad hoc group call participation in the MC network.

Another aspect of the disclosure is to provide that a partner MC server detects a criteria for each MC client of a plurality of MC clients available in the MC network. The criteria are used to determine addition or removal of the MC client into the ad hoc group call.

Another aspect of the disclosure is to provide that the partner MC server determines whether to add or remove a MC client to the established ad hoc group call, when the criteria corresponding to the MC client meets or no longer meets during the established ad hoc group call.

Another aspect of the disclosure is to provide that the partner MC server transmits an ad hoc group call add user notification message to a primary MC server, when the criteria to add the MC client to the established ad hoc group call is met. The ad hoc group call add user notification message includes a MC service ad hoc group identifier associated with the ad hoc group call, and a MC service identifier list meeting the criteria specified in the ad hoc group call.

Another aspect of the disclosure is to provide that the partner MC server transmits an ad hoc group call remove user notification message to the primary MC server, when the criteria to remove the MC client from the established ad hoc group call is met. The ad hoc group call remove user notification message includes the MC service ad hoc group identifier associated with the ad hoc group call, and the MC service identifier list meeting the criteria specified in the ad hoc group call.

Another aspect of the disclosure is to provide that the partner MC server receives an ad hoc group call release notification message from the primary MC server to stop determining the ad hoc group call participants using the criteria. The ad hoc group call release notification message includes the MC service group identifier associated with the ad hoc group call.

Another aspect of the disclosure is to provide that the primary MC server detects the criteria for each MC client of the plurality of MC clients available in the MC network. The criteria are used to determine addition or removal of the MC client into the ad hoc group call.

Another aspect of the disclosure is to provide that the primary MC server receives one of the ad hoc group call remove user notification message and the ad hoc group call add user notification message from the partner MC server based on the criteria specified by the MC client.

Another aspect of the disclosure is to provide that the primary MC server transmits the ad hoc group call request message to the MC client to add the MC client to the established ad hoc group call and receive an hoc group call response message accepting participation of the MC client to the established ad hoc group call when the ad hoc group call add user notification message is received.

Another aspect of the disclosure is to provide that the primary MC server transmits the ad hoc group call leave request message to the MC client to remove the MC client from the established ad hoc group call and receive the hoc group call leave response message accepting removal of the MC client from the established ad hoc group call when the ad hoc group call remove user notification message is received.

Another aspect of the disclosure is to provide that the primary MC server transmits an ad hoc group call release request message to the MC client from the plurality of MC clients.

Another aspect of the disclosure is to provide that the primary MC server transmits an ad hoc group call release request message to the partner MC server to stop determining the ad hoc group call participants using the criteria.

Another aspect of the disclosure is to provide that the primary MC server receives an ad hoc group call release response message from the MC client. The ad hoc group call release notification message includes a MC service group identifier associated with the ad hoc group call.

Additional aspects will be set forth in part in the description which follows and, in part, will be apparent from the description, or may be learned by practice the presented embodiments.

In accordance with an aspect of the disclosure, a method for handling ad hoc group call participation in a MC network 1000 by a partner MC server 106 is provided. The method includes transmitting an ad hoc group call add user notification message to a primary MC server 104 when a criteria to add a MC client to an established ad hoc group call is met. The ad hoc group call add user notification message includes a MC service ad hoc group identifier associated with the ad hoc group call, and a MC service identifier list meeting the criteria specified in the ad hoc group call. In another embodiment, when the criteria to remove the MC client from the established ad hoc group call is met, the method includes transmitting an ad hoc group call remove user notification message to the primary MC server 104.

In accordance with another aspect of the disclosure, a method for handling an ad hoc group call participation in a MC network is provided. The method includes establishing, by a partner MC server, an ad hoc group call with a set of MC client from a plurality of MC clients based on a criteria specified by a MC client. Further, the method includes detecting, by the partner MC server, the criteria for each MC client of the plurality of MC clients available in the MC network. The criteria are used to determine addition or removal of the MC client into the ad hoc group call. Further, the method includes determining, by the partner MC server, whether to add or remove a MC client to the established ad hoc group call, when the criteria corresponding to the MC client meets or no longer meets during the established ad hoc group call. In another embodiment, when the criteria to add the MC client to the established ad hoc group call is met, the method includes transmitting an ad hoc group call add user notification message to a primary MC server. The ad hoc group call add user notification message includes a MC service ad hoc group identifier associated with the ad hoc group call, and a MC service identifier list meeting the criteria specified in the ad hoc group call. In another embodiment, when the criteria to remove the MC client from the established ad hoc group call is met, the method includes transmitting an ad hoc group call remove user notification message to the primary MC server. The ad hoc group call remove user notification message includes a MC service ad hoc group identifier associated with the ad hoc group call, and a MC service identifier list meeting the criteria specified in the ad hoc group call.

In yet another embodiment, the method includes receiving, by the partner MC server, an ad hoc group call release notification message from the primary MC server to stop determining the ad hoc group call participants using the criteria. The ad hoc group call release notification message includes a MC service group identifier associated with the ad hoc group call.

In yet another embodiment, the criteria are passed by an initiator of the ad hoc group call while establishing the ad hoc group call.

In yet another embodiment, the criteria are modified by an authorized user of the established ad hoc group call.

In accordance with another aspect of the disclosure, a method for handling an ad hoc group call participation in a MC network is provided. The method includes establishing, by a primary MC server, an ad hoc group call with a set of MC client from a plurality of MC clients based on a criteria specified by a MC client. Further, the method includes detecting, by the primary MC server, the criteria for each MC client of the plurality of MC clients available in the MC network. The criteria are used to determine addition or removal of the MC client into the ad hoc group call. Further, the method includes receiving, by the primary MC server, one of an ad hoc group call remove user notification message and an ad hoc group call add user notification message from a partner MC server based on the criteria specified by the MC client. In yet another embodiment, when the ad hoc group call add user notification message is received, the method includes transmitting an ad hoc group call request message to the MC client to add the MC client to the established ad hoc group call and receiving an hoc group call response message accepting participation of the MC client to the established ad hoc group call. In another embodiment, when the ad hoc group call remove user notification message is received, the method includes transmitting an ad hoc group call leave request message to the MC client to remove the MC client from the established ad hoc group call and receiving an hoc group call leave response message accepting removal of the MC client from the established ad hoc group call.

In yet another embodiment, the method includes transmitting, by the primary MC server, an ad hoc group call release request message to the MC client from the plurality of MC clients. Further, the method includes transmitting, by the primary MC server, an ad hoc group call release request message to the partner MC server to stop determining the ad hoc group call participants using the criteria. Further, the method includes receiving, by the primary MC server, an ad hoc group call release response message from the MC client. The ad hoc group call release notification message includes a MC service group identifier associated with the ad hoc group call.

In accordance with another aspect of the disclosure, a partner MC server for handling an ad hoc group call participation in a MC network is provided. The partner MC server includes an ad hoc group call participation controller communicatively coupled to memory and a processor. The ad hoc group call participation controller is configured to establish an ad hoc group call with a set of MC client from a plurality of MC clients based on a criteria specified by a MC client. Further, the ad hoc group call participation controller is configured to detect the criteria for each MC client of the plurality of MC clients available in the MC network. The criteria are used to determine addition or removal of the MC client into the ad hoc group call. Further, the ad hoc group call participation controller is configured to determine whether to add or remove a MC client to the established ad hoc group call, when the criteria corresponding to the MC client meets or no longer meets during the established ad hoc group call. In yet another embodiment, the ad hoc group call participation controller is configured to transmit an ad hoc group call add user notification message to a primary MC server, when the criteria to add the MC client to the established ad hoc group call is met. The ad hoc group call add user notification message includes a MC service ad hoc group identifier associated with the ad hoc group call, and a MC service identifier list meeting the criteria specified in the ad hoc group call. In another embodiment, the ad hoc group call participation controller is configured to transmit an ad hoc group call remove user notification message to the primary MC server, when the criteria to remove the MC client from the established ad hoc group call is met. The ad hoc group call remove user notification message includes a MC service ad hoc group identifier associated with the ad hoc group call, and a MC service identifier list meeting the criteria specified in the ad hoc group call.

In accordance with another aspect of the disclosure, a primary MC server for handling an ad hoc group call participation in a MC network is provided. The primary MC server includes an ad hoc group call participation controller communicatively coupled to memory and a processor. The ad hoc group call participation controller is configured to establish an ad hoc group call with a set of MC client from a plurality of MC clients based on a criteria specified by a MC client. Further, the ad hoc group call participation controller is configured to detect the criteria for each MC client of the plurality of MC clients available in the MC network. The criteria are used to determine addition or removal of the MC client into the ad hoc group call. Further, the ad hoc group call participation controller is configured to receive one of an ad hoc group call remove user notification message and an ad hoc group call add user notification message from a partner MC server based on the criteria specified by the MC client. In yet another embodiment, when the ad hoc group call add user notification message is received, the ad hoc group call participation controller is configured to transmit an ad hoc group call request message to the MC client to add the MC client to the established ad hoc group call and receiving an hoc group call response message accepting participation of the MC client to the established ad hoc group call. In another embodiment, when the ad hoc group call remove user notification message is received, the ad hoc group call participation controller is configured to transmit an ad hoc group call leave request message to the MC client to remove the MC client from the established ad hoc group call and receiving an hoc group call leave response message accepting removal of the MC client from the established ad hoc group call.

The disclosure provides an effective and efficient method for handling an ad hoc group call participation in the MC network.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A and 1B show a flow diagram of existing mechanism of an ad hoc group call setup involving multiple MCPTT systems, according to the related art;

FIGS. 2A and 2B show a flow diagram of a MCPTT server modifying ad hoc group call participants involving multiple MCPTT systems (e.g., MCPTT providers) in a MC network, according to various embodiments of the disclosure;

FIG. 3 shows a flow diagram of a MCPTT server stopping a determination of ad hoc group call participants involving multiple MCPTT systems, according to an embodiment of the disclosure;

FIG. 4 shows various hardware components of a partner MC server, according to an embodiment of the disclosure;

FIG. 5 shows various hardware components of a primary MC server, according to an embodiment of the disclosure;

FIG. 6 is a flowchart illustrating a method, implemented by a partner MC server, for handling an ad hoc group call participation in a MC network, according to an embodiment of the disclosure; and

FIG. 7 is a flowchart illustrating a method, implemented by a primary MC server, for handling an ad hoc group call participation in a MC network, according to an embodiment of the disclosure.

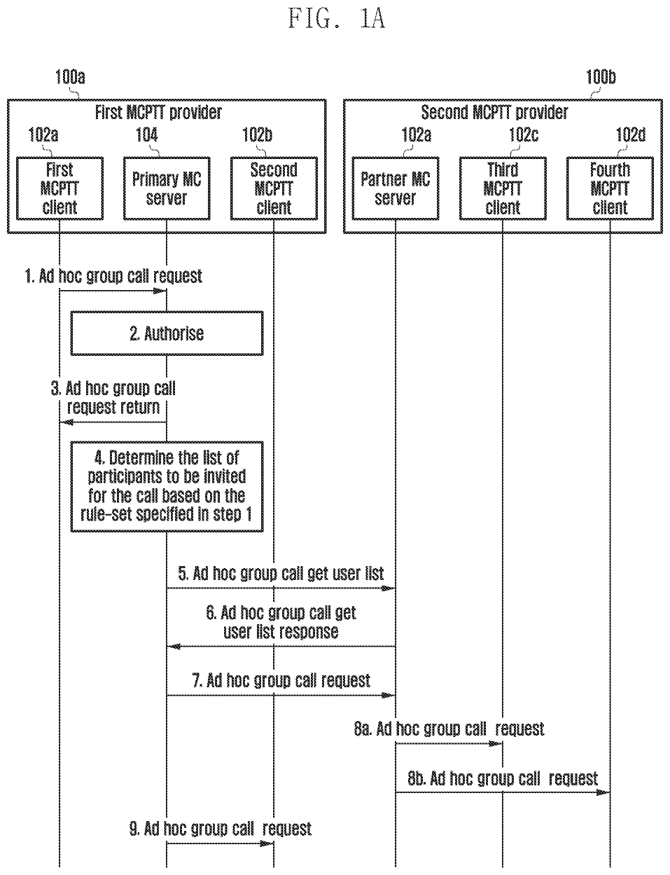

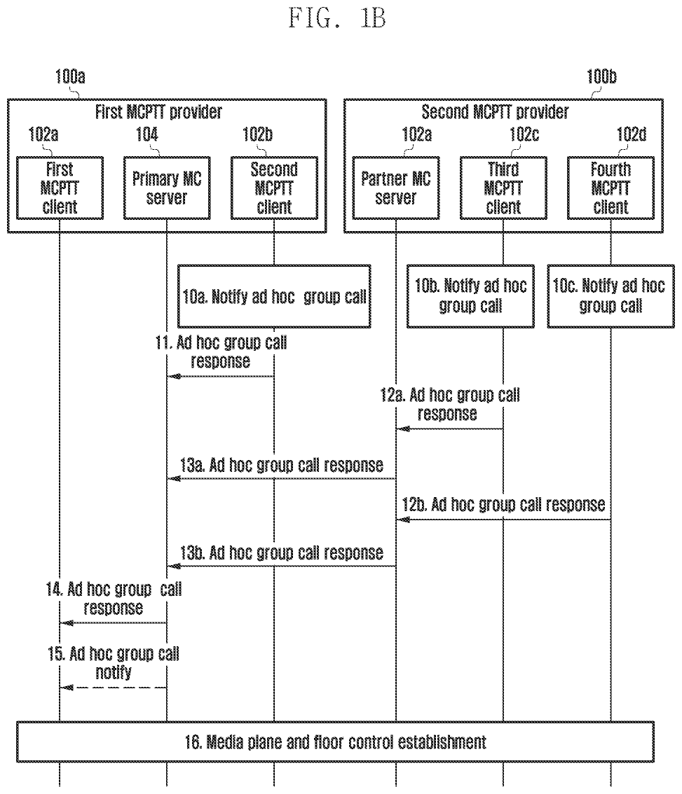

The same reference numerals are used to represent the same elements throughout the drawing.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Also, the various embodiments described herein are not necessarily mutually exclusive, as some embodiments may be combined with one or more other embodiments to form new embodiments.

The term “or” as used herein, refers to a non-exclusive or, unless otherwise indicated. The examples used herein are intended merely to facilitate an understanding of ways in which the embodiments herein may be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be appreciated that the blocks in each flowchart and combinations of the flowcharts may be performed by one or more computer programs which include instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphical processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

The terms “MCPTT client” and “MC client” are used interchangeably in the patent disclosure. The terms “MCPTT” and “MC” are used interchangeably in the patent disclosure. The terms “MCPTT user” and “MC user” are used interchangeably in the patent disclosure.

Embodiments disclosed herein provide a method for handling an ad hoc group call participation in a MC network. The method includes establishing, by a partner MC server, an ad hoc group call with a set of MC client from a plurality of MC clients based on a criteria specified by a MC client. Further, the method includes detecting, by the partner MC server, the criteria for each MC client of the plurality of MC clients available in the MC network. The criteria are used to determine addition or removal of the MC client into the ad hoc group call. Further, the method includes determining, by the partner MC server, whether to add or remove a MC client to the established ad hoc group call, when the criteria corresponding to the MC client meets or no longer meets during the established ad hoc group call. In an embodiment, when the criteria to add the MC client to the established ad hoc group call is met, the method includes transmitting an ad hoc group call add user notification message to a primary MC server. The ad hoc group call add user notification message includes a MC service ad hoc group identifier associated with the ad hoc group call, and a MC service identifier list meeting the criteria specified in the ad hoc group call. In another embodiment, when the criteria to remove the MC client from the established ad hoc group call is met, the method includes transmitting an ad hoc group call remove user notification message to the primary MC server. The ad hoc group call remove user notification message includes a MC service ad hoc group identifier associated with the ad hoc group call, and a MC service identifier list meeting the criteria specified in the ad hoc group call.

Based on the proposed method, the ad hoc group call setup may involve a MC service user from multiple MC systems. In the ad hoc group call setup, a primary MC system will be the responsible for handling of the ad hoc group call. The ad hoc group call needs to involve a partner system based on an agreement and a criteria for determining a participants list. Then, all the involved partner MC systems will be responsible to provide participants from the MC system those who meet the criteria or no longer meet the criteria. During the call setup of the ad hoc group call, the primary MC system uses the criteria to determine the MC service users who may participate in the call. The primary MC system sends the ad hoc group call get userlist request along with the criteria to determine the participants to the partner MC system. On receiving of the request, the MC services user who meets the criteria are returned to the primary MC system. The primary MC system invites all the determined MC service user to the ad hoc group call. The primary and partner MC systems continuous to monitor and determine the MC service users based on the criteria. During continuous determination of MC service users by the partner MC system, if any of the MC service user meets or no longer meet the criteria, the primary MC system is notified using newly defined information elements such as ad hoc group call add user notification and Ad hoc group call remove user notifications respectively. On receiving of the notifications, the MC services user who meets the criteria are added to the on-going ad hoc group call by sending the ad hoc group call request and those MC services users who no longer meets the criteria are removed from the ongoing ad hoc group call by sending the Ad hoc group call leave request. Similarly, once the on-going ad hoc group call is released then the partner MC system is notified to stop determining the participants for the ad hoc group call using the criteria by sending the newly defined information element such as ad hoc group call release notification or any existing information element and ad hoc group call release request along with other information. The proposed method may be used for public safety agency and railways related requirement and is required procedure for a mission critical push-to-talk (MCPTT) service, a MCVideo service and a MCData service.

Based on the proposed method, a below mechanism which aids in the proper handling of the MC service users from the partner MC system and to determine the MC service users who may participate in the call based on the criteria:
a. Notify the primary MC system on continuous determination of the MC service user from the partner system based on the criteria. The MC service user meets or no longer meet the criteria. Based on the notification, the MC service users are either added to the ongoing ad hoc group call or removed from the ongoing ad hoc group call.
b. Notify about the release of the ad hoc group call to the partner MC system to stop determining the participants for the ad hoc group call.

In other words, the proposed method assists in notifying the primary MC system on continuous determination of the MC service user from the partner system and notifying about release of the ad hoc group call to the partner MC system to stop determining the participants for the ad hoc group call. The proposed method assists in notifying the primary MC system on continuous determination of the MC service user from the partner system based on the criteria and notifying about the release of the ad hoc group call to the partner MC system to stop determining the participants for the ad hoc group call. Thus, results in avoiding the signaling resource wastage while handling the ad hoc group call participation in the MC network.

The proposed method allows an authorized user to initiate the ad hoc group call involving multiple users from different MC system in case of normal operating procedures, emergency situations etc. and manage all the users from different MC system.

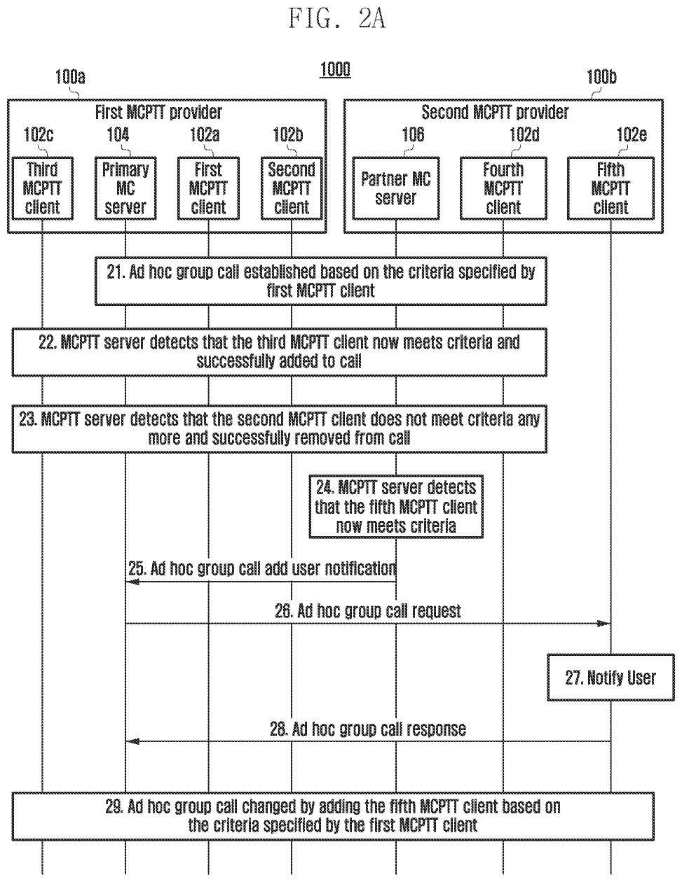

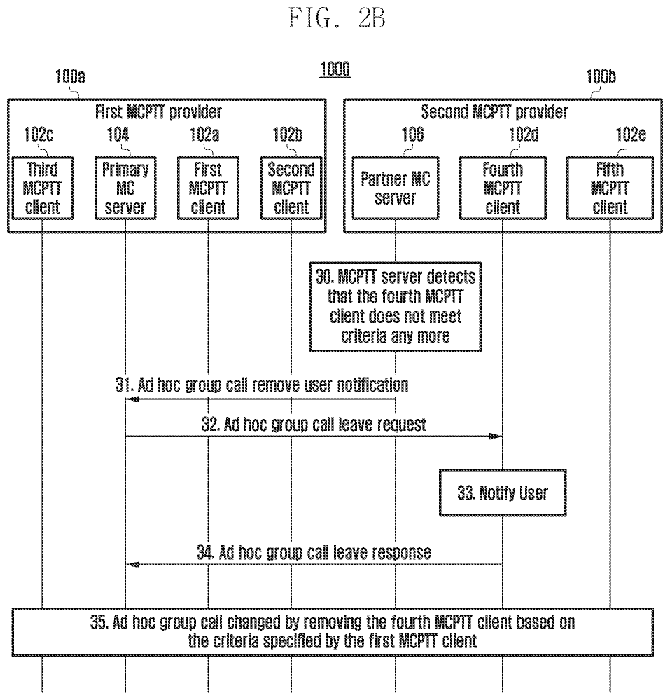

Referring now to the drawings and more particularly to FIGS. 2A, 2B, and 3 to 7, where similar reference characters denote corresponding features consistently throughout the figures, there are shown preferred embodiments.

FIGS. 2A and 2B show a flow diagram of a MCPTT server modifying ad hoc group call participants involving multiple MCPTT systems (e.g., MCPTT providers) in a MC network, according to various embodiments of the disclosure.

Referring to FIGS. 2A and 2B a high level procedure for the MCPTT server modifying ad hoc group call participants in multiple MCPTT systems is illustrated.

The detailed operations are as below. Below are pre-conditions for handling the ad hoc group call participants:
1. A MCPTT user at a first MCPTT client 102a is authorized to initiate the ad hoc group call.
2. The primary and partner MC server determine the participants for the ad hoc group call based on the criteria specified by the first MCPTT client 102a while initiating the ad hoc group call.
3. The primary and partner MC server continuously evaluate the criteria to monitor the list of users who meets or not meets the criteria for participating in the on-going ad hoc group call.
4. A primary MC server (e.g., primary MCPTT server) detects that a third MCPTT client 102c satisfies the criteria and a second MCPTT client 102b stops to meet the criteria specified by the first MCPTT client 102a.
5. A partner MC server (e.g., partner MCPTT server or the like) detects that a fifth MCPTT client 102e satisfies the criteria and a fourth MCPTT client 102d stops to meet the criteria specified by the first MCPTT client 102a.

Below are operations for handling the ad hoc group call participants:
1. At operation 21, the ad hoc group call is established and on-going with the participants (i.e., first MCPTT client 102a, second MCPTT client 102b, and fourth MCPTT client 102d). The participant's list is determined by both primary and partner systems MCPTT server based on the criteria specified by the first MCPTT client 102a while initiating the call.
2. At operation 22, the primary MC server 104 detects that the third MCPTT client 102c now meets criteria and successfully added to the call.
3. At operation 23, the primary MC server 104 detects that the second MCPTT client 102b does not meet criteria anymore and successfully removed from the call.
4. At operation 24, the partner MC server 106 detects that the fifth MCPTT client 102e satisfies the criteria specified by the MCPTT client.
5. At operation 25, the partner MC server 106 sends the notification to the primary MCPTT system to add the MCPTT user at the fifth MCPTT client 102e to the on-going ad hoc group call.
6. At operation 26, the primary MC server 104 sends the ad hoc group call request to the fifth MCPTT client 102e.
7. At operation 27, the fifth MCPTT client 102e notifies the user about the incoming ad hoc group call.
8. At operation 28, the fifth MCPTT client 102e accepts the ad hoc group call request and sends an ad hoc group call response to the primary MC server 104.
9. At operation 29, the on-going ad hoc group call is updated by adding the fifth MCPTT client 102e which satisfies the criteria specified by the first MCPTT client 102a.
10. At operation 30, the partner MC server 106 detects that the fourth MCPTT client 102d is no more satisfying the criteria to be the participant of the ad hoc group call.
11. At operation 31, the partner MC server 106 sends the notification to the primary MCPTT system to remove the MCPTT user at the fourth MCPTT client 102d from the on-going ad hoc group call.
12. At operation 32, the primary MC server 104 sends the ad hoc group call leave request to the fourth MCPTT client 102d and removes it from the on-going ad hoc group call.
13. At operation 33, the fourth MCPTT client 102d notifies the user of the ad hoc group call leave request.
14. At operation 34, the fourth MCPTT client 102d sends the ad hoc group call leave response to the primary MC server 104.
15. At operation 35, the on-going ad hoc group call is updated by removing the fourth MCPTT client 102d, which no more satisfies the criteria specified by the first MCPTT client 102a.

In another embodiment, instead of using two different notifications such as ad hoc group call add user notification and ad hoc group call remove user notifications, a single notification such as ad hoc group call update user's notification is used to provide the list of MC service users who are meeting the criteria and no longer meeting the criteria. The operations 25 and 31 may use the information element such as ad hoc group call update user's notification with the list of users.

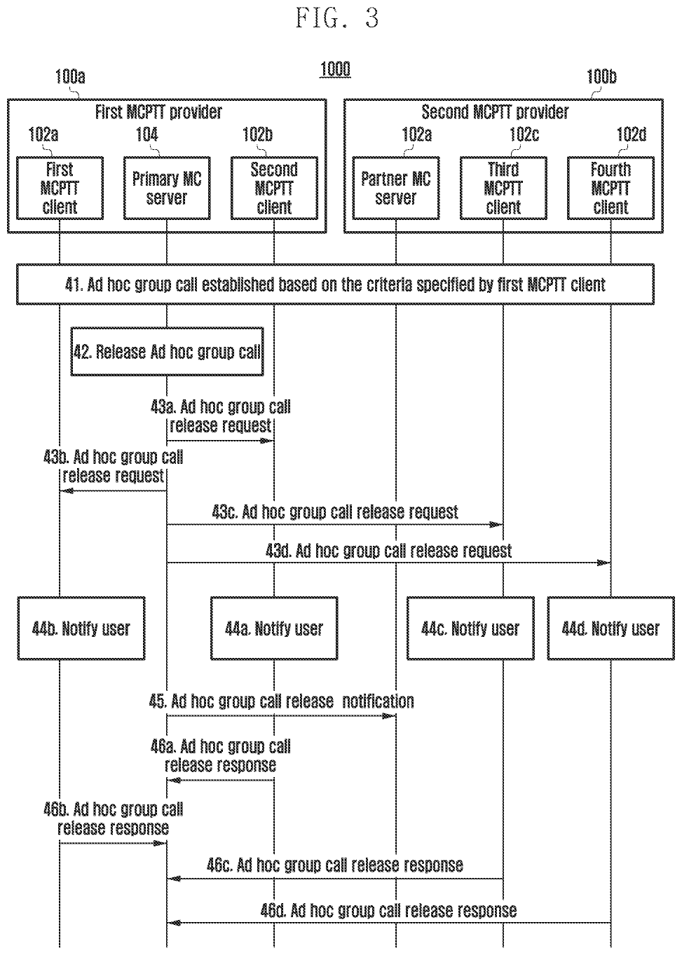

FIG. 3 shows a flow diagram of the MCPTT server stopping the determination of ad hoc group call participants in the multiple MCPTT systems, according to an embodiment of the disclosure. The detailed operations are as below.

Referring to FIG. 3, below are pre-conditions for stopping the determination of ad hoc group call participants in the multiple MCPTT systems:
1. The MCPTT user at the first MCPTT client 102a is authorized to initiate the ad hoc group call.
2. The primary and partner MC servers determine the participants for the ad hoc group call based on the criteria specified by the first MCPTT client 102a while initiating the ad hoc group call.
3. The primary and partner MC servers continuously evaluate the criteria to monitor the list of users who meets or not meets the criteria for participating in the on-going ad hoc group call.

Below are procedure operations for stopping the determination of ad hoc group call participants in the multiple MCPTT systems:
1. At operation 41, the ad hoc group call is established and on-going with the participants (such as first MCPTT client 102a, second MCPTT client 102b, third MCPTT client 102c, and fourth MCPTT client 102d). The participant's list is determined by both primary and partner systems MCPTT server based on the criteria specified by the first MCPTT client 102a while initiating the call.
2. At operation 42, the primary MC server 104 detects that the ad hoc group call which is ongoing is to be released e.g., due to hang time expiry, last participant leaving, second last participant leaving, initiator leaving, or minimum number of affiliated MC service group members are not present.
3. At operations 43a, 43b, 43c and 43d, the primary MC server 104 sends the ad hoc group call release request to all the participants of the ad hoc group call.
4. At operations 44a, 44b, 44c and 44d, the MCPTT clients 102a-102d notify the user about the release of the ad hoc group call.
5. At operation 45, the primary MC server 104 sends the notification to the partner MCPTT system about the ad hoc group call release to stop determining of the participants list by the partner MCPTT system.
6. At operations 46a, 46b, 46c and 46d, all the participants of the ad hoc group call receive the ad hoc group call release request and sends the ad hoc group call release response to the primary MC server 104.

In another embodiment, instead of defining new procedure, the ad hoc group call release procedure involving multiple system is used to send the notification to the partner MCPTT system about the ad hoc group call release to stop determining of the participants list by partner MCPTT system. The operation 45 may be used as is in the ad hoc group call release procedure involving multiple MC systems.

Below information elements are defined to use in the newly proposed procedures.
1. Ad hoc group call add user notification (MC service server to MC service server). Table X describes the information flow Ad hoc group call add user notification from one MC service server to another MC service server. The notification is to provide the list of MC service IDs meeting the criteria specified in the ad hoc group communication get userlist request from one MC service server to another MC service server.

TABLE X
Ad hoc group call add user notification

| Information element | Status | Description |
|---|---|---|
| MC service ad hoc | M | The MC service group ID associated |
| group ID | (mandatory) | with the ad hoc group communication |
| MC service ID list | M | List of MC service IDs meeting the |
| | | criteria specified in the ad hoc group |
| | | communication get user list |

2. Ad hoc group call remove user notification (MC service server—MC service server): Table Y describes the information flow Ad hoc group call remove user notification from one MC service server to another MC service server. The notification is to provide the list of MC service IDs no longer meeting the criteria specified in the ad hoc group communication get userlist request from one MC service server to another MC service server.

TABLE Y
Ad hoc group call remove user notification

| Information element | Status | Description |
|---|---|---|
| MC service ad hoc | M | The MC service group ID associated |
| group ID | | with the ad hoc group communication |
| MC service ID list | M | List of MC service IDs no longer meeting |
| | | the criteria specified in the ad hoc group |
| | | communication get user list |

3. Ad hoc group call release notification (MC service server—MC service server): Table Z describes the information flow Ad hoc group call release notification from one MC service server to another MC service server. The notification is to indicate to stop evaluating the criteria to determine the participants list if another MC service server is having the criteria specified in the ad hoc group communication get userlist request.

TABLE Z
Ad hoc group call release notification

| Information element | Status | Description |
|---|---|---|
| MC service ad hoc group | M | The MC service group ID associated |
| ID | | with the ad hoc group communication |

4. Ad hoc group call update users' notification (MC service server—MC service server): Table A describes the information flow Ad hoc group call update user's notification from one MC service server to another MC service server to add the list of MC service users to ongoing ad hoc group call or/and remove from the ongoing ad hoc group call.

TABLE A
Ad hoc group call update users notification

| Information element | Status | Description |
|---|---|---|
| MC service ad hoc | M | The MC service group ID associated |
| group ID | | with the ad hoc group communication |
| MC service ID list | O | List of MC service IDs meeting the |
| (see NOTE) | | criteria specified in the ad hoc group |
| | | communication get userlist |
| MC service ID list | O | List of MC service IDs no longer meeting |
| (see NOTE) | | the criteria specified in the ad hoc group |
| | | communication get userlist |

NOTE:
Either one or both of these information elements is present

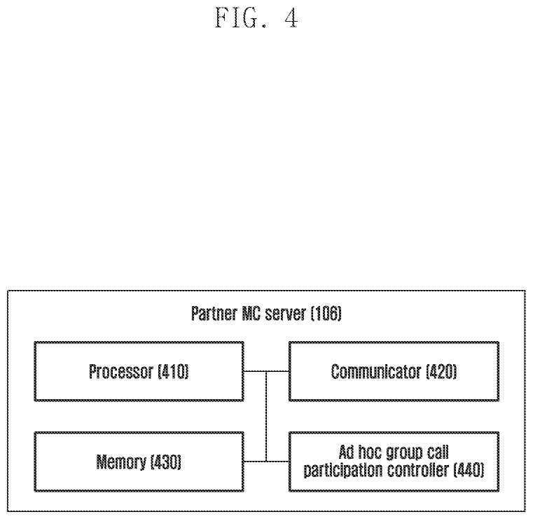

FIG. 4 shows various hardware components of a partner MC server, according to an embodiment of the disclosure.

Referring to FIG. 4, the partner MC server 106 includes a processor 410, a communicator 420, a memory 430 and an ad hoc group call participation controller 440. The processor 410 is coupled with the communicator 420, the memory 430 and the ad hoc group call participation controller 440.

The ad hoc group call participation controller 440 establishes the ad hoc group call with the set of MC client from the plurality of MC clients 102a-102d based on the criteria specified by the MC client. In an embodiment, the criteria are passed by an initiator of the ad hoc group call while establishing the ad hoc group call. In another embodiment, the criteria are modified by the authorized user of the established ad hoc group call. Further, the ad hoc group call participation controller 440 detects the criteria for each MC client of the plurality of MC clients available in the MC network 1000. The criteria are used to determine addition or removal of the MC client into the ad hoc group call. Further, the ad hoc group call participation controller 440 determines whether to add or remove the MC client to the established ad hoc group call, when the criteria corresponding to the MC client meets or no longer meets during the established ad hoc group call. In yet another embodiment, the ad hoc group call participation controller 440 transmits the ad hoc group call add user notification message to the primary MC server 104, when the criteria to add the MC client to the established ad hoc group call is met. The ad hoc group call add user notification message includes the MC service ad hoc group identifier associated with the ad hoc group call, and the MC service identifier list meeting the criteria specified in the ad hoc group call. In another embodiment, the ad hoc group call participation controller 440 transmits the ad hoc group call remove user notification message to the primary MC server 104, when the criteria to remove the MC client from the established ad hoc group call is met. The ad hoc group call remove user notification message includes the MC service ad hoc group identifier associated with the ad hoc group call, and the MC service identifier list meeting the criteria specified in the ad hoc group call. Thus, results in avoiding the signaling resource wastage while handling the ad hoc group call participation in the MC network 1000.

In yet another embodiment, the ad hoc group call participation controller 440 receives the ad hoc group call release notification message from the primary MC server 104 to stop determining the ad hoc group call participants using the criteria. The ad hoc group call release notification message includes the MC service group identifier associated with the ad hoc group call.

The ad hoc group call participation controller 440 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor 410 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 410 may include multiple cores and is configured to execute the instructions stored in the memory 430.

Further, the processor 410 is configured to execute instructions stored in the memory 430 and to perform various processes. The communicator 420 is configured for communicating internally between internal hardware components and with external devices via one or more networks. The memory 430 also stores instructions to be executed by the processor 410. The memory 430 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 430 may, in some examples, be considered a non-transitory storage medium. The term “non-transitory” may indicate that the storage medium is not embodied in a carrier wave or a propagated signal. However, the term “non-transitory” should not be interpreted that the memory 430 is non-movable. In certain examples, a non-transitory storage medium may store data that can, over time, change (e.g., in Random Access Memory (RAM) or cache).

In yet another embodiment, the communicator 420 includes an electronic circuit specific to a standard that enables wired or wireless communication. The communicator 420 is configured to communicate internally between internal hardware components of the external devices via one or more networks.

Although the FIG. 4 shows various hardware components of the partner MC server 106 but it is to be understood that other embodiments are not limited thereon. In other embodiments, the partner MC server 106 may include less or more of a number of components. Further, the labels or names of the components are used only for illustrative purpose and does not limit the scope of the disclosure. One or more components may be combined together to perform same or substantially similar function in the partner MC server 106.

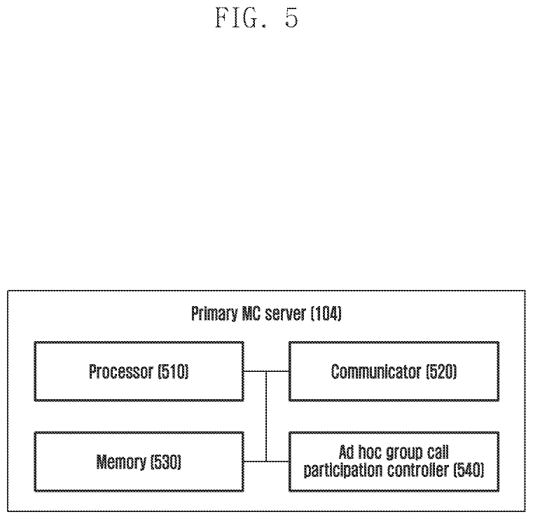

FIG. 5 shows various hardware components of a primary MC server, according to an embodiment of the disclosure.

Reviewing FIG. 5, the primary MC server 104 includes a processor 510, a communicator 520, a memory 530 and an ad hoc group call participation controller 540. The processor 510 is coupled with the communicator 520, the memory 530 and the ad hoc group call participation controller 540.

The ad hoc group call participation controller 540 establishes the ad hoc group call with the set of MC client from the plurality of MC clients 102a-102d based on the criteria specified by the MC client. Further, the ad hoc group call participation controller 540 detects the criteria for each MC client of the plurality of MC clients available in the MC network 1000. The criteria are used to determine addition or removal of the MC client into the ad hoc group call. Further, the ad hoc group call participation controller 540 receives one of the ad hoc group call remove user notification message and the ad hoc group call add user notification message from the partner MC server 106 based on the criteria specified by the MC client. In an embodiment, when the ad hoc group call add user notification message is received, the ad hoc group call participation controller 540 transmits the ad hoc group call request message to the MC client to add the MC client to the established ad hoc group call and receives the hoc group call response message accepting participation of the MC client to the established ad hoc group call. In another embodiment, when the ad hoc group call remove user notification message is received, the ad hoc group call participation controller 540 transmits the ad hoc group call leave request message to the MC client to remove the MC client from the established ad hoc group call and receives the hoc group call leave response message accepting removal of the MC client from the established ad hoc group call. Thus, results in avoiding the signalling resource wastage while handling the ad hoc group call participation in the MC network 1000.

In yet another embodiment, the ad hoc group call participation controller 540 transmits the ad hoc group call release request message to the MC client from the plurality of MC clients. Further, the ad hoc group call participation controller 540 transmits the ad hoc group call release request message to the partner MC server 106 to stop determining the ad hoc group call participants using the criteria. Further, the ad hoc group call participation controller 540 receives the ad hoc group call release response message from the MC client. The ad hoc group call release notification message includes a MC service group identifier associated with the ad hoc group call.

The ad hoc group call participation controller 540 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor 510 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 510 may include multiple cores and is configured to execute the instructions stored in the memory 530.

Further, the processor 510 is configured to execute instructions stored in the memory 530 and to perform various processes. The communicator 520 is configured for communicating internally between internal hardware components and with external devices via one or more networks. The memory 530 also stores instructions to be executed by the processor 510. The memory 530 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 530 may, in some examples, be considered a non-transitory storage medium. The term “non-transitory” may indicate that the storage medium is not embodied in a carrier wave or a propagated signal. However, the term “non-transitory” should not be interpreted that the memory 530 is non-movable. In certain examples, a non-transitory storage medium may store data that can, over time, change (e.g., in Random Access Memory (RAM) or cache).

In yet another embodiment, the communicator 520 includes an electronic circuit specific to a standard that enables wired or wireless communication. The communicator 520 is configured to communicate internally between internal hardware components of the external devices via one or more networks.

Although the FIG. 5 shows various hardware components of the primary MC server 104 but it is to be understood that other embodiments are not limited thereon. In other embodiments, the primary MC server 104 may include less or more of a number of components. Further, the labels or names of the components are used only for illustrative purpose and does not limit the scope of the disclosure. One or more components may be combined together to perform same or substantially similar function in the primary MC server 104.

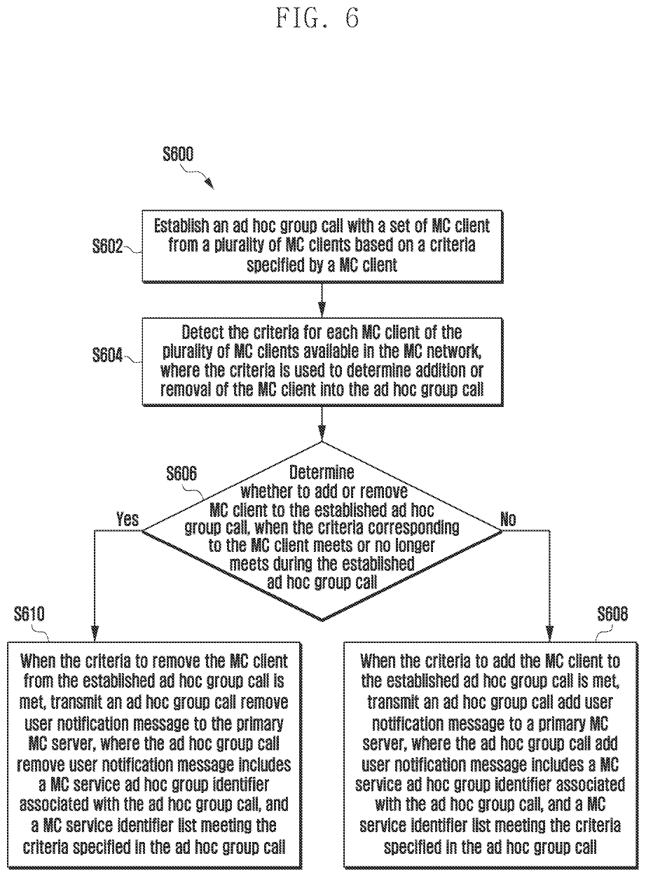

FIG. 6 is a flowchart illustrating a method, implemented by a partner MC server, for handling an ad hoc group call participation in a MC network, according to an embodiment of the disclosure.

Referring to FIG. 6, in a method 8600, the operations 8602-8610 are handled by the Ad hoc group call participation controller 440.

At operation 8602, the method includes establishing the ad hoc group call with the set of MC client from the plurality of MC clients based on the criteria specified by the MC client. At operation 8604, the method includes detecting the criteria for each MC client of the plurality of MC clients available in the MC network 1000. The criteria are used to determine addition or removal of the MC client into the ad hoc group call. At operation 8606, the method includes determining whether to add or remove the MC client to the established ad hoc group call, when the criteria corresponding to the MC client meets or no longer meets during the established ad hoc group call.

In an embodiment, when the criteria to add the MC client to the established ad hoc group call is met, At operation 8608, the method includes transmitting the ad hoc group call add user notification message to the primary MC server 104. The ad hoc group call add user notification message includes the MC service ad hoc group identifier associated with the ad hoc group call, and the MC service identifier list meeting the criteria specified in the ad hoc group call. In another embodiment, when the criteria to remove the MC client from the established ad hoc group call is met, At operation 8610, the method includes transmitting the ad hoc group call remove user notification message to the primary MC server 104. The ad hoc group call remove user notification message includes the MC service ad hoc group identifier associated with the ad hoc group call, and the MC service identifier list meeting the criteria specified in the ad hoc group call.

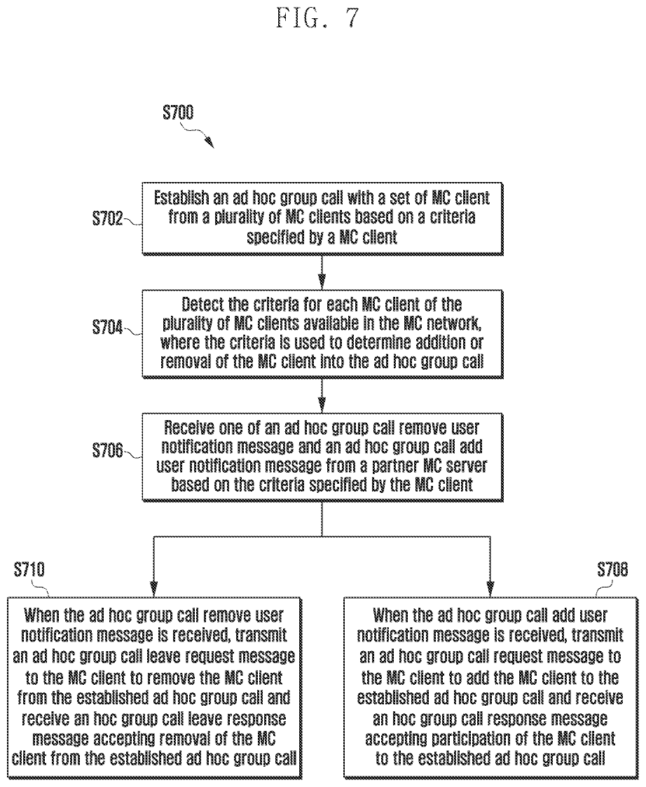

FIG. 7 is a flowchart illustrating a method, implemented by the primary MC server, for handling the ad hoc group call participation in the MC network, according to an embodiment of the disclosure.

Referring to FIG. 7, in a method S700, the operations S702-S710 are handled by the Ad hoc group call participation controller 540.

At operation S702, the method includes establishing the ad hoc group call with the set of MC client from the plurality of MC clients based on the criteria specified by the MC client. At operation S704, the method includes detecting the criteria for each MC client of the plurality of MC clients available in the MC network 1000. The criteria are used to determine addition or removal of the MC client into the ad hoc group call. At operation S706, the method includes receiving one of the ad hoc group call remove user notification message and the ad hoc group call add user notification message from the partner MC server 106 based on the criteria specified by the MC client.

In an embodiment, when the ad hoc group call add user notification message is received, at operation S708, the method includes transmitting the ad hoc group call request message to the MC client to add the MC client to the established ad hoc group call and receive the hoc group call response message accepting participation of the MC client to the established ad hoc group call. In another embodiment, when the ad hoc group call remove user notification message is received, At operation S710, the method includes transmitting the ad hoc group call leave request message to the MC client to remove the MC client from the established ad hoc group call and receive the hoc group call leave response message accepting removal of the MC client from the established ad hoc group call.

The method may be used to avoid the signalling resource wastage while handling the ad hoc group call participation in the MC network 1000.

The various actions, acts, blocks, operations, or the like in the methods S600 and S700 may be performed in the order presented, in a different order or simultaneously. Further, in some embodiments, some of the actions, acts, blocks, operations, or the like may be omitted, added, modified, skipped, or the like without departing from the scope of the disclosure.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first mission critical push to talk (MCPTT) server in a communication system, the method comprising:
identifying whether a MCPTT client meets criteria used to determine addition or removal of a MCPTT client; and
in case that the MCPTT client meets the criteria and is not in an ad hoc group call, transmitting, to a second MCPTT server, a first notification message to add the MCPTT client to the ad hoc group call,
wherein the MCPTT client and the second MCPTT server are in different MCPTT system.

2. The method of claim 1, further comprising:
in case that the MCPTT client does not meets the criteria and is in the ad hoc group call, transmitting, to the second MCPTT server, a second notification message to remove the MCPTT client from the ad hoc group call,
wherein the second notification message comprises information on service ID list no longer meeting the criteria.

3. The method of claim 1, wherein the first notification message comprises information on service ID list meeting the criteria.

4. The method of claim 1, further comprising:
in case that the ad hoc group call is to be released by second MCPTT server, receiving, from the second MCPTT server, a third notification message to notify releasing of the ad hoc group call,
wherein the third notification message indicates to stop evaluating the criteria.

5. A method performed by a second mission critical push to talk (MCPTT) server in a communication system, the method comprising:
in case that a MCPTT client meets criteria and is not in an ad hoc group call, receiving, from a first MCPTT server, a first notification message to add the MCPTT client to the ad hoc group call,
wherein the MCPTT client and the second MCPTT server are in different MCPTT system.

6. The method of claim 5, further comprising:
in case that the MCPTT client does not meets the criteria and is in the ad hoc group call, receiving, from the first MCPTT server, a second notification message to remove the MCPTT client from the ad hoc group call,
wherein the second notification message comprises information on service ID list no longer meeting the criteria.

7. The method of claim 5, wherein the first notification message comprises information on service ID list meeting the criteria.

8. The method of claim 5, further comprising:
identifying that the ad hoc group call is to be released; and
transmitting, to the first MCPTT server, a third notification message to notify releasing of the ad hoc group call,
wherein the third notification message indicates to stop evaluating the criteria.

9. A first mission critical push to talk (MCPTT) server in a communication system, the first MCPTT server comprising:
a transceiver; and
at least one processor coupled with the transceiver and configured to:
identify whether a MCPTT client meets criteria used to determine addition or removal of a MCPTT client, and
in case that the MCPTT client meets the criteria and is not in an ad hoc group call, transmit, to a second MCPTT server, a first notification message to add the MCPTT client to the ad hoc group call,
wherein the MCPTT client and the second MCPTT server are in different MCPTT system.

10. The first MCPTT server of claim 9, wherein the at least one processor is configured to:
in case that the MCPTT client does not meets the criteria and is in the ad hoc group call, transmit, to the second MCPTT server, a second notification message to remove the MCPTT client from the ad hoc group call,
wherein the second notification message comprises information on service ID list no longer meeting the criteria.

11. The first MCPTT server of claim 9, wherein the first notification message comprises information on service ID list meeting the criteria.

12. The first MCPTT server of claim 9, wherein the at least one processor is configured to:
in case that the ad hoc group call is to be released by second MCPTT server, receive, from the second MCPTT server, a third notification message to notify releasing of the ad hoc group call,
wherein the third notification message indicates to stop evaluating the criteria.

13. A second mission critical push to talk (MCPTT) server in a communication system, the second MCPTT server comprising:
a transceiver; and
at least one processor coupled with the transceiver and configured to:
in case that a MCPTT client meets criteria and is not in an ad hoc group call, receive, from a first MCPTT server, a first notification message to add the MCPTT client to the ad hoc group call,
wherein the MCPTT client and the second MCPTT server are in different MCPTT system.

14. The second MCPTT server of claim 13, wherein the at least one processor is configured to:
in case that the MCPTT client does not meets the criteria and is in the ad hoc group call, receive, from the first MCPTT server, a second notification message to remove the MCPTT client from the ad hoc group call,
wherein the second notification message comprises information on service ID list no longer meeting the criteria.

15. The second MCPTT server of claim 13, wherein the first notification message comprises information on service ID list meeting the criteria.

16. The second MCPTT server of claim 13, wherein the at least one processor is configured to:
identify that the ad hoc group call is to be released, and
transmit, to the first MCPTT server, a third notification message to notify releasing of the ad hoc group call,
wherein the third notification message indicates to stop evaluating the criteria.
